(19) United States
(12) Patent Application Publication
(10) Pub. No.: US 2006/0196727 A1
(43) Pub. Date: Sep. 7, 2006

(54) Method of adapting an automatic greasing apparatus for hydraulic track tensioning

(76) Inventors: Troy R. Shields, Rocky Mountain House (CA); Pamela A. Crowley, Rocky Mountain House (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/061,201

(22) Filed: Feb. 18, 2005

(51) Int. Cl. F16N 13/16

(52) U.S. Cl. 184/29

(57) ABSTRACT

A method of using an automatic greasing apparatus for hydraulic track tensioning. The method comprises the steps of providing a pressure control valve having an inlet, at least one primary outlet and a pressure relief outlet; connecting the automatic greasing apparatus to a supply conduit leading to the inlet of the pressure control valve, so that the automatic greasing apparatus is adapted to discharge grease into the supply conduit at periodic intervals without regard to system pressure; connecting the at least one primary outlet to at least one fluid pressurized conduit leading to the hydraulic tensioning apparatus, the pressure control valve opening the at least one primary outlet to permit a flow of additional grease upon the pressure in the fluid pressurized conduit falling below a preset pressure threshold; and connecting a grease return conduit from the pressure relief outlet to a reservoir of the automatic greasing apparatus, upon pressure rising in the supply conduit above a preset level, the pressure control valve opening the pressure relief outlet to divert surplus grease through the grease return conduit back to the reservoir of the automatic greasing apparatus.

### FIELD OF THE INVENTION

The present invention relates to an automatic greasing system for hydraulic track tensioning.

### BACKGROUND OF THE INVENTION

Automatic hydraulic track tensioning apparatus operated from a pressure pump are well known. Examples can be found in the following U.S. Pat. Nos. 2,818,311 (Ashley et al 1957); U.S. Pat. Nos. 3,101,977 (Hyler et al 1963); U.S. Pat. Nos. 3,765,730 (Ishida 1973); U.S. Pat. Nos. 4,458,954 (Haas 1984); U.S. Pat. Nos. 4,681,376 (Riml 1987); U.S. Pat. Nos. 5,005,920 (Kinsinger 1991); and U.S. Pat. Nos. 5,165,765 (Baylor 1992). Unfortunately, there has not been sufficient demand for such automatic systems to encourage commercial production and bring the price down. As a result, most hydraulic track tensioning is manually performed using grease guns.

Automatic greasing apparatus are commercially available at a reasonable price from such vendors as Lincoln Industrial Corporation and Alemite Corporation. However, automatic greasing apparatus are not suitable for automatically supplying fluid to operate a hydraulic track tensioning apparatus. Automatic greasing apparatus commercially available supply grease at preset intervals. These intervals are determined by a timer or, in some models, triggered by vibration switches during operation of the machine.

### SUMMARY OF THE INVENTION

What is required is a method of adapting an automatic greasing apparatus for hydraulic track tensioning.

According to the present invention there is provided a method of using an automatic greasing apparatus for hydraulic track tensioning. The method involves a first step of providing a pressure control valve having an inlet, at least one primary outlet and a pressure relief outlet. A second step of connecting an automatic greasing apparatus to a supply conduit leading to the inlet of the pressure control valve, so that the automatic greasing apparatus is adapted to discharge grease into the supply conduit at periodic intervals without regard to system pressure. A third step of connecting the at least one primary outlet to at least one fluid pressurized conduit leading to the hydraulic tensioning apparatus. The pressure control valve is adapted to open the at least one primary outlet to permit a flow of additional grease upon the pressure in the fluid pressurized conduit falling below a preset pressure threshold. A fourth step involves connecting a grease return conduit from the pressure relief outlet to a reservoir of the automatic greasing apparatus. Upon pressure rising in the supply conduit above a preset level, the pressure control valve opens the pressure relief outlet to divert surplus grease through the grease return conduit back to the reservoir of the automatic greasing apparatus.

Beneficial results may be realized by positioning one way valves on each of the supply conduit, the fluid pressurized conduit and the grease return conduit, so that flow can only go in one direction.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a block diagram of an automatic greasing system according to an aspect of the invention;

FIG. 2 is a block diagram of another embodiment of the automatic greasing system; and

FIG. 3 is a block diagram of another embodiment of the automatic greasing system.

### DETAILED DESCRIPTION OF THE PREFERRED EMBODIMENT

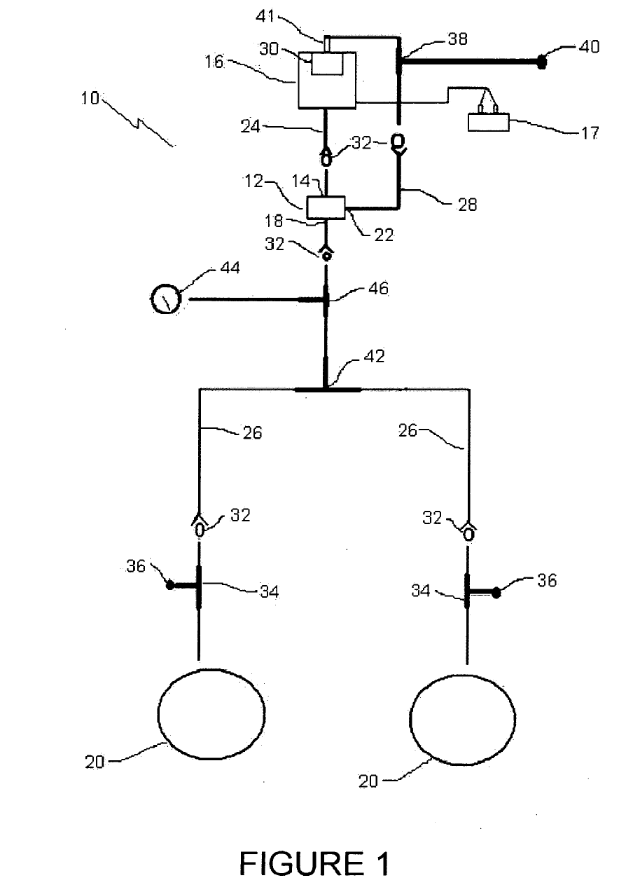

The preferred embodiment, an automatic greasing system, generally identified by reference numeral 10, will now be described with reference to FIGS. 1 through 3.

Structure and Relationship of Parts

Referring now to FIG. 1, there is shown a pressure control valve 12 having an inlet 14 connected to an automatic greasing apparatus 16. Automatic greasing apparatus is powered by a power supply 17, such as a 12 V power source. Pressure control valve 12 also has a primary outlet 18 connected to hydraulic tensioning apparatus 20 by fluid pressurized conduits 24. A pressure relief outlet 22 is connected to pressure control valve 12 and automatic greasing apparatus 16. A supply conduit 24 leads from automatic greasing apparatus 16 to inlet 14 of pressure control valve 12, so that automatic greasing apparatus 16 is adapted to discharge grease into supply conduit 24 at periodic intervals without regard to system pressure. Fluid pressurized conduits 26 lead from primary outlet 18 of pressure control valve 12 to hydraulic tensioning apparatus 20 such that pressure control valve 12 can open primary outlet 18 to permit a flow of additional grease upon the pressure in fluid pressurized conduits 26 falling below a preset pressure threshold. A grease return conduit 28 extends from pressure relief outlet 22 to a reservoir 30 of automatic greasing apparatus 16. Upon pressure rising in supply conduit 24 above a preset level, pressure control valve 12 opens pressure relief outlet 22 to divert surplus grease through grease return conduit 28 back to reservoir 30 of automatic greasing apparatus 16.

There is also shown in FIG. 1 one way valves 32. These ensure that grease flows in the correct direction through automatic greasing system 10. For example, one way valve 32 located along supply conduit 24 ensures that grease flows from automatic greasing apparatus 16 to pressure control valve 12. A tee valve 42 is connected at the intersection of fluid pressurized conduits 26 to ensure that equal pressure is directed to hydraulic tensioning apparatus 20. A pressure gauge 44 is attached to a tee valve 46 to allow a user to determine the pressure along pressurized conduits 26. There are also located tee valves 34 with grease nipples 36 attached along pressurized conduits 26. Tee valves 34 allow a user to manually supply grease to hydraulic tensioning apparatus 20. There is also a tee valve 38 with a grease nipple 40 connected to a filling port 41 to allow a user to manually supply automatic greasing apparatus 16 with grease.

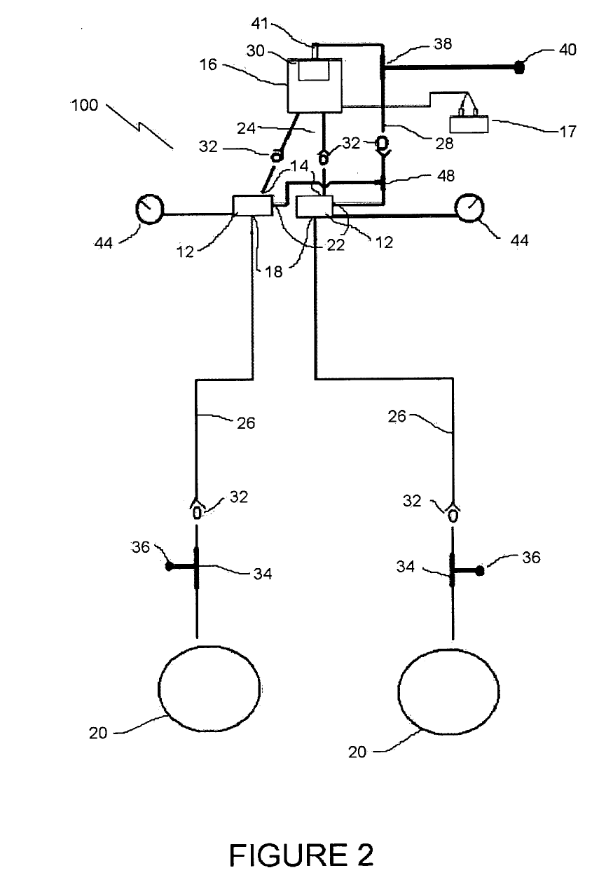

Referring now to FIG. 2, another embodiment of an automatic greasing system 100 is shown. In this embodiment, two pressure control valves 12 are used to control each hydraulic tensioning apparatus individually. Each pressure control valve 12 has a pressure gauge 44 to determine the pressure along pressurized supply conduits 26, which no longer require tee valve 42. There is, however, a tee valve 48 inserted along grease return conduit 28 such that both pressure control valves 12 are able to divert surplus grease. There are also shown two fluid pressurized conduits 24 connecting automating greasing apparatus 16 to pressure control valves 12, such that each receives grease independently of the other.

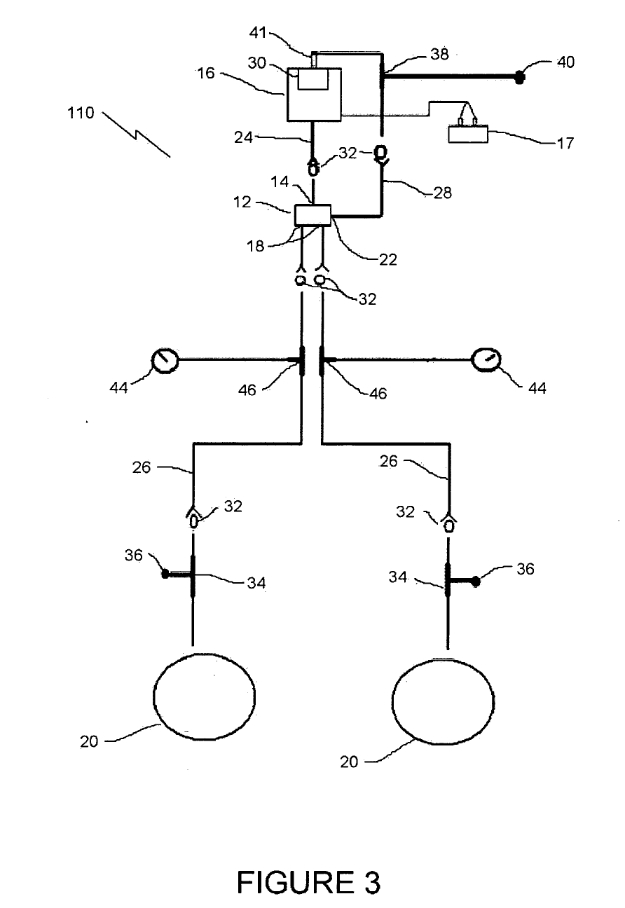

Referring now to FIG. 3 another embodiment of an automatic greasing system 110 is shown, where one pressure control valve 12 controls two separate pressurized supply conduits 26 which are not connected by a tee valve 42. This necessitates two primary outlets 18 on pressure control valve 12.

Other combinations of pressure control valves 12 and automatic greasing apparatus 16 may be apparent to those skilled in the art.

Operation:

The operation and use of automatic greasing system 10 will now be discussed with reference to FIG. 1. It will be understood that automatic greasing systems 100 and 110 as shown in FIGS. 2 and 3 operate under similar principles. Referring to FIG. 1, the various parts of automatic greasing system 10 are connected as discussed above. Automatic greasing apparatus 16 is supplied with grease through filling port 41. Automatic greasing apparatus 16 supplies pressure control valve 12 with grease through supply conduit 24, one way valve 32, and inlet 14. If pressure in supply conduit 24 rises above a preset level, pressure control valve 12 opens pressure relief outlet 22 to divert surplus grease through grease return conduit 28 back to reservoir 30 of automatic greasing apparatus 16. When the pressure in fluid pressurized conduits 26 falls below a preset pressure threshold, primary outlet 18 is opened to permit a flow of additional grease. The grease flows through tee valve 46 with pressure gauge 44 attached to allow a user to monitor pressure in pressurized conduits 26. Grease then flows through tee valve 42 which ensures that equal pressure is directed to each hydraulic tensioning apparatus 20. Tee valves 34 and grease nipples 36 that allow a user to manually insert grease into hydraulic tensioning apparatus 20 and one way valves 32 are also located along pressurized conduits 26. 5 In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art-that modifications may be made to the illustrated embodiment without departing from the spirit and scope of the invention as hereinafter defined in the Claims.

The embodiments of the invention in which an exclusive property or privilege is claimed are defined as follows:

1. A method of using an automatic greasing apparatus for hydraulic track tensioning, comprising the steps of:
providing a pressure control valve having an inlet, at least one primary outlet and a pressure relief outlet;
connecting the automatic greasing apparatus to a supply conduit leading to the inlet of the pressure control valve, so that the automatic greasing apparatus is adapted to discharge grease into the supply conduit at periodic intervals without regard to system pressure;
connecting the at least one primary outlet to at least one fluid pressurized conduit leading to the hydraulic tensioning apparatus, the pressure control valve opening the at least one primary outlet to permit a flow of additional grease upon the pressure in the fluid pressurized conduit falling below a preset pressure threshold;
connecting a grease return conduit from the pressure relief outlet to a reservoir of the automatic greasing apparatus, upon pressure rising in the supply conduit above a preset level, the pressure control valve opening the pressure relief outlet to divert surplus grease through the grease return conduit back to the reservoir of the automatic greasing apparatus.

2. The method as defined in claim 1, one way valves being positioned on each of the supply conduit, the fluid pressurized conduit and the grease return conduit, so that flow can only go in one direction.

3. In combination:
a pressure control valve having an inlet, at least one primary outlet and a pressure relief outlet;
an automatic greasing apparatus;
a supply conduit leading from the automatic greasing apparatus to the inlet of the pressure control valve, so that the automatic greasing apparatus is adapted to discharge grease into the supply conduit at periodic intervals without regard to system pressure;
at least one fluid pressurized conduit leading from the at least one primary outlet of the pressure control valve to the hydraulic tensioning apparatus, the pressure control valve opening the at least one primary outlet to permit a flow of additional grease upon the pressure in the fluid pressurized conduit falling below a preset pressure threshold;
a grease return conduit extending from the pressure relief outlet to a reservoir of the automatic greasing apparatus, upon pressure rising in the supply conduit above a preset level, the pressure control valve opening the pressure relief outlet to divert surplus grease through the grease return conduit back to the reservoir of the automatic greasing apparatus.
